(19) United States
(12) Patent Application Publication
(10) Pub. No.: US 2010/0198632 A1
(43) Pub. Date: Aug. 5, 2010

(54) Method, System, and Apparatus for Categorizing and Presenting Risk Based Analytical Results

(76) Inventor: Amrinder S. Arora, Centreville, VA (US)

Correspondence Address: MAXVALUEIP CONSULTING, 11204 ALBERMYRTLE ROAD, POTOMAC, MD, 20854, US

(21) Appl. No.: 12/364,492

(22) Filed: Feb. 2, 2009

(51) Int. Cl. G06Q 10/00

(52) U.S. Cl. 705/7

(57) ABSTRACT

A system for computing, categorizing and presenting risk based analytical results to a human user for a cargo port security is presented. The system computes analytical results and presents that to the human user in a variety of configurable displays, allowing the user to evaluate the transaction on particular subset of data elements (also called aspect or facet) and a particular viewpoint (also called perspective or intelligence source). The system also enables the human user to compare the transaction to similar transactions (by allowing the user to define “similar”) from relevant past time periods (by allowing the user to define “relevant” periods).

### BACKGROUND OF THE INVENTION

In today's world, software systems are used in a variety of decision making roles. They often help the analyst (or reviewer, inspector, etc) in making a more informed decision about a transaction by computationally evaluating the transactions using large amounts of conditions and computing a variety of measures for the transactions. It is in this scenario that the presented invention plays a role.

Take a scenario/an example: A customs inspector views the details of hundreds of cargo shipments arriving at that inspector's port. Since the inspector does not have the time to inspect all the shipments, he/she would like to inspect the ones that present high risk and would like the risk evaluation system to present the analysis in a manner that would allow the user to make the best decision.

Consider a different scenario: A financial analyst is monitoring millions of international financial transactions and would like to find the ones that present a high risk. Again, the analyst would like the risk evaluation system to present the analysis so that she can easily dismiss the ones that present less risk and focus on the ones that present high risk.

Consider a third scenario: A food safety reviewer has tens of stores to visit for surprise inspections and does not have the time to visit them all. He would like the risk evaluation system to allow him to easily compare the relative merits of the various stores and make the informed decision after that.

We observe that in each of these examples, the inspector/reviewer/analyst has different needs and requires different ways to access the risk evaluation results and needs to be able to customize the view to make the best decision.

Thus, there is a well-understood need for a system that can categorize and present the risk evaluation results and can organize the results as per the user's requirements. Past approaches to this problem have used customized solution for each business vertical and did not have the configurability by time period, configurability of facets and perspectives, the weighting and have not presented the results using highlighting rules that can be customized.

The invented system relates to risk assessment, wherein a software system is used to present the results of the risk analysis.

### SUMMARY OF THE INVENTION

The claimed system provides a method and system for categorizing and presenting risk based analytical results to a human user. The system takes analytical results and presents that to the human user in a variety of configurable displays, allowing the user to evaluate the transaction on particular subset of data elements (also called aspect or facet) and a particular viewpoint (also called perspective or intelligence source). The system also enables the human user to compare the transaction to similar transactions (by allowing the user to define “similar”) from relevant past time periods (by allowing the user to define “relevant” periods).

### BRIEF DESCRIPTION OF THE DRAWINGS

FIG. 1 illustrates the components of the claimed risk based analytical system.

FIG. 2 illustrates the components of the risk computation and result display subsystem.

FIG. 3 illustrates the perspective management system.

FIG. 4 illustrates the facet management system.

FIG. 5 illustrates how the risk analysis results are presented to the user.

FIG. 6 illustrates how the score details, which can be contributed by multiple rules and conditions, are presented to the user.

### DETAILED DESCRIPTION OF THE PREFERRED EMBODIMENTS

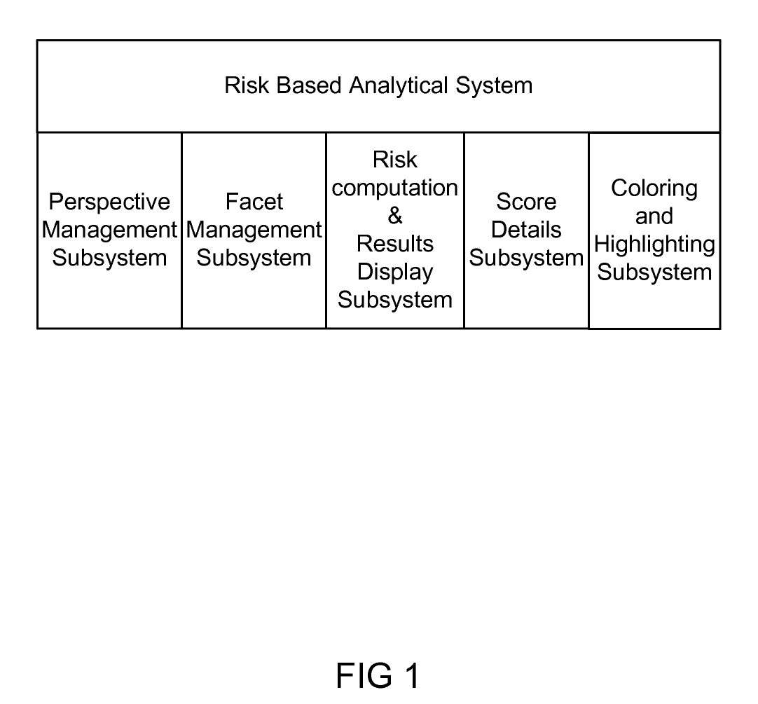

The preferred embodiment of this invention is a risk based analysis system for computing and presenting the risk analysis results for shipments arriving at a cargo port for inspection and security screening to a port inspector. The components of the invented risk based analysis system are shown in FIG. 1. These components are:
Risk computation and results display subsystem
   time group selection module
   transaction group selection module
perspective management subsystem
facet management subsystem
coloring and highlighting subsystem
score details subsystem

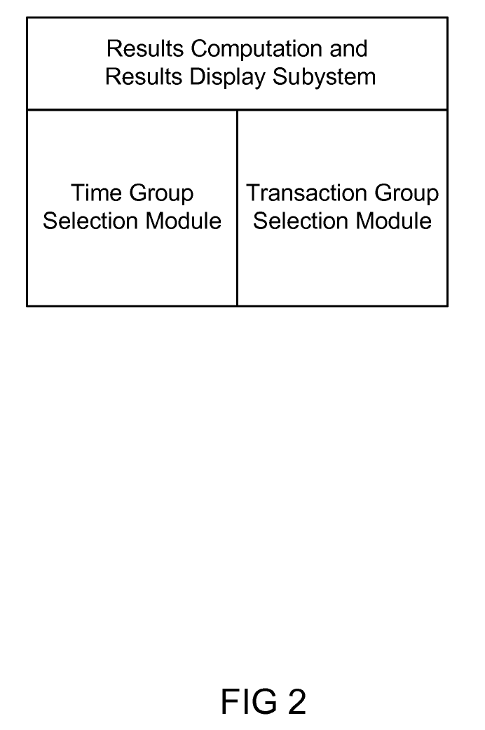

The first and the main component of the invented risk based analysis system is the risk computation and results display subsystem shown in FIG. 2. The risk computation and results display subsystem makes use of time group selection transaction group selection modules. These two modules present a subset of shipment data to the risk computation and results display subsystem for processing and display.

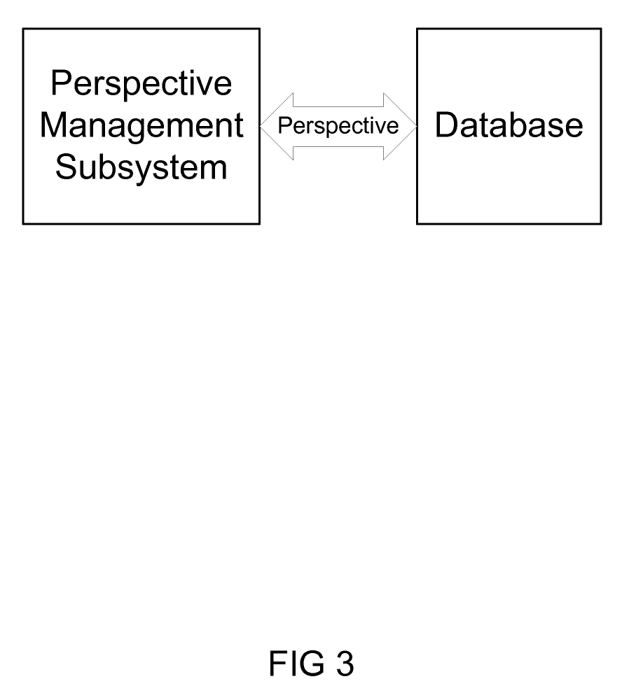

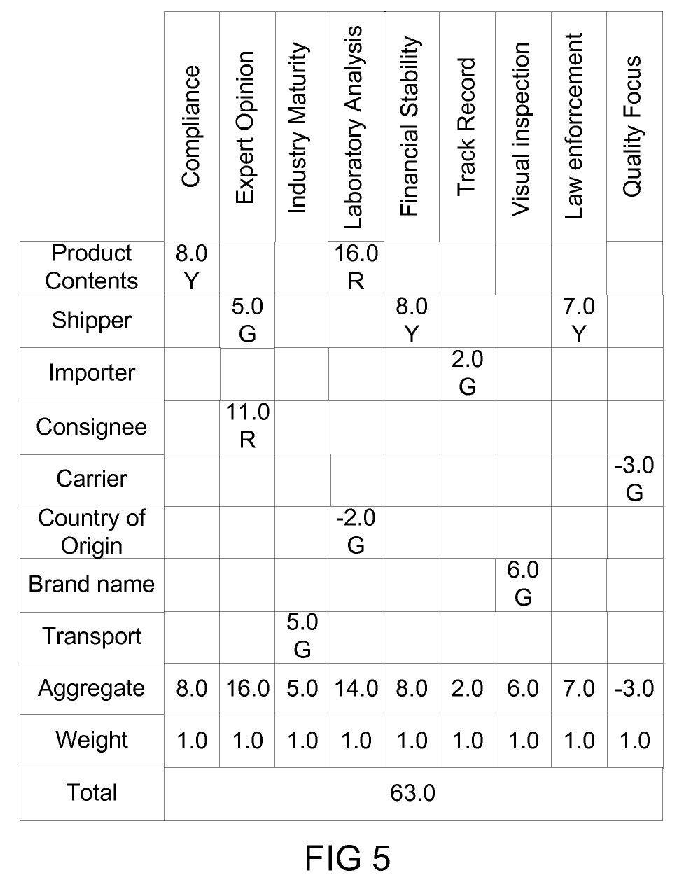

The second component of the invented risk based analysis system is the perspective or view point management system shown in FIG. 3. The perspective management system retrieves the perspectives from the database for computing risks and showing the results to the user. It allows the user to modify perspectives and saves the modified perspectives back into the database. The horizontal axis of FIG. 5 shows an example of a number of perspectives used in cargo shipment port security.

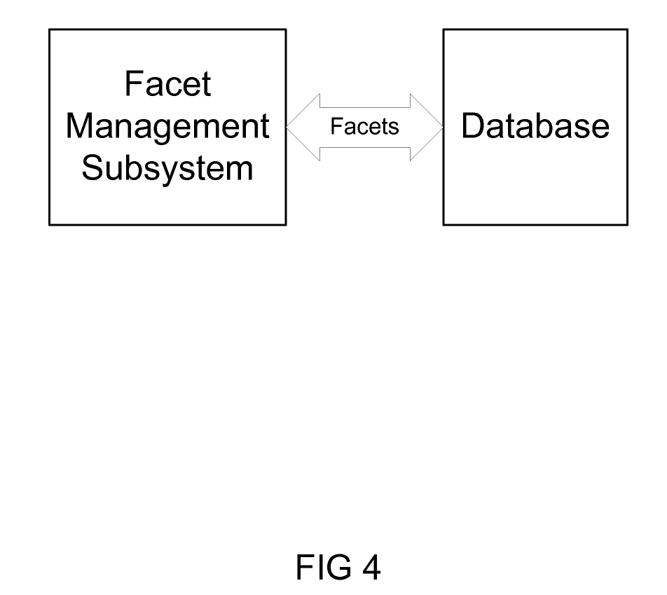

The third component of the invented risk based analysis system is the facet management subsystem shown in FIG. 4. The facet management system retrieves the facets from the database for computing risk and showing the results to the user. It allows the user to modify facets depending upon business vertical and other requirements and saves the modified facets back into the database. The vertical axis of FIG. 5 shows an example of a number of facets used in cargo shipment port security.

The fourth component of the invented risk based analysis system is the coloring and highlighting subsystem. This subsystem is responsible for highlighting the risk elements that have scores above a preconfigured threshold for that element. The highlighting of risk elements may be in the form of adding special symbols, using specific fonts or styling or changing the text or background fill color of the element or changing the cursor.

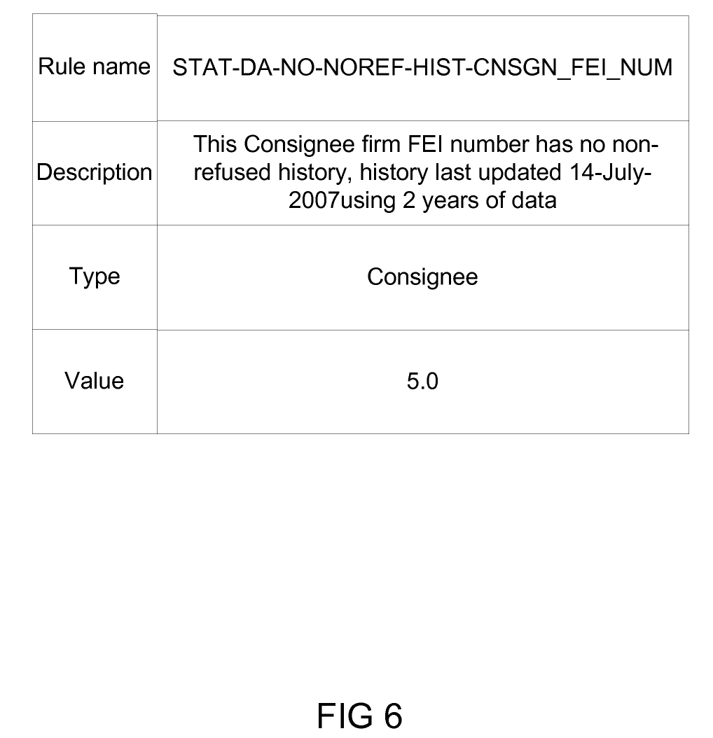

The fifth component of the invented risk based analysis system is the score details subsystem. An example of such subsystem is shown in FIG. 6. This subsystem keeps track of scoring rules that are configured in the system along with their description, type and value for each shipment.

The system builds a two dimensional risk matrix, for each shipment within some selected time periods and subgroups of shipments. The two dimensions of the matrix are aspects (also called facets) and perspectives (also called viewpoints). FIG. 5 shows an example of such risk matrix. Examples of facets commonly used in the risk matrix are product contents, shipper, importer, consignee, carrier, country of origin, brand name and transport. Examples of perspectives commonly used in the risk matrix are compliance, expert opinion, industry maturity, laboratory analysis, financial stability, track record, visual inspection, law enforcement and quality focus.

The relevant elements of the risk matrix are filled with risk scores for the transaction. The risk scores are computed by comparison to past statistical information of user predefined set of shipments stored and learnt by the system over time as well as policy enforcements such as alerts from government security agencies. The risk scores are computed from percentiles of probability distribution function, which are calculated using standard and fuzzy logic algorithms depending on whether the risk merits are based on an absolute, relative or a vague values.

The risk scores can be positive or negative, and for each element of the risk matrix, risk scores at different thresholds are marked differently. For example, scores below a low-end user preconfigured threshold can be marked as Green, risk score above a high-end user preconfigured threshold can be marked as Red and risk scores in between the high-end and low-end threshold can be marked as Yellow. In the example shown in FIG. 5, the Green, Yellow and Red are denoted by letters “G”, “Y”, and “R” in each of the relevant matrix elements.

The score details subsystem allows the user to view the details of a score for an element and view the rules and conditions that contributed to that specific score.

A weight is assigned to each perspective, facet or facet/perspective combination by port authorities, which is configured in the system and may be changed by port inspector in response to policy changes or alerts received from security agencies. The system remembers past weights and can automatically recalibrate weights based on the objectives identified by the user (for example, the port inspector).

The aggregate risk score of each perspective is calculated as the sum of the risk scores of all elements of that perspective. The total calculated risk score of a shipment is calculated by multiplying the weight of each risk matrix element by the score of that element and computing the sum of the results.

The invented risk based analysis system highlights shipments that have a total calculated risk score that is above a certain preconfigured threshold, which will aid the port inspector to make an informed decision, such as further inspection of the shipment.

The invented risk based analysis system may be used as a standalone system or may be added to an existing risk evaluation system.

The system that processes the comparison and performs risk analysis uses (as an example, comprises) a microprocessor, a database, a local storage, a user interface, a communication media, a risk analyzer module, a rule storage, an over-riding module, a comparison module, and a temporary listing/ranking module.

Any variations of the above teachings are also meant to be protected by our application.

1. A system for computing and presenting risk analysis results of shipments to a user, said system comprising:
a results display subsystem;
a perspective management subsystem;
a facet management subsystem;
a coloring and highlighting subsystem; and
a score details subsystem;
wherein said results display subsystem displays risk scores and matrix of cells for said risk scores;
wherein facets and perspectives are the two dimensions of said matrix;
wherein said perspective management subsystem allows said user to define and modify said perspectives for said risk scores of said shipments;
wherein said facet management subsystem allows said user to define and modify said facets of said shipments;
wherein said coloring and highlighting subsystem colors or highlights said cells that meet said user's certain specified criteria using symbols, fonts, styling, or colors and allows said user to modify said criteria; and
wherein said score details subsystem allows said user to view details of first of said risk scores corresponding to first of said cells and view rules and conditions that contributed to said first of said risk score.

2. A system as recited in claim 1, wherein said system is added to or works with an existing risk evaluation system.

3. A system as recited in claim 1, wherein said system aids a reviewer or an analyst in making a decision.

4. A system as recited in claim 1, wherein said system allows said user to compare various said shipments or groups of said shipments on their absolute, relative or fuzzy risk merits.

5. A system as recited in claim 1, wherein said system allows said user to configure sets of said shipments that should be used to compare with the current shipment.

6. A system as recited in claim 1, wherein said system is embedded as a risk result display system within another system.

7. A system as recited in claim 1, wherein said system allows said user to configure said perspectives of said shipments as measured by different subsystems.

8. A system as recited in claim 1, wherein said system allows said user to configure said facets of said shipments depending upon business vertical model.

9. A system as recited in claim 1, wherein said system allows different weights for each of said facets, said perspectives or said facets and said perspectives combination, wherein said weights are used to calculate total risk score.

10. A system as recited in claim 1, wherein said system remembers past said weights and automatically recalibrates said weights based on objectives identified by said user.

11. A system as recited in claim 1, wherein said system computes said risk scores by comparison of a shipment to past statistical information of a predefined set of said shipments stored and learnt by said system over time.

12. A system as recited in claim 1, wherein said system computes said risk scores by comparison of a shipment to preconfigured values based on security policy.

13. A system as recited in claim 1, wherein said system computes said risk scores from percentiles of probability distribution function, wherein said percentiles are calculated using standard or fuzzy logic algorithms.

14. A system as recited in claim 1, wherein said coloring and highlighting subsystem colors subsets of said cells of said matrix differently based on the risk scores and the specified thresholds.

15. A system as recited in claim 1, wherein said system allows said user to define relevant periods.

16. A system as recited in claim 1, wherein said system allows said user to define similarity metrics or parameters.

17. A system as recited in claim 9, wherein said total risk score corresponding to said matrix is computed by multiplying said risk scores of said cells by said weights of said cells and calculating sum of said multiplications.

18. A system as recited in claim 1, wherein said system is used in cargo port security screening.

19. A system as recited in claim 1, wherein said system is fully automatic, wherein said user has no overwrite permission of any elements of said system.

20. A system as recited in claim 1, wherein said system is semi-automatic, wherein said user has overwrite permission for one or more elements of said system.
